(19) United States
(12) Patent Application Publication
(10) Pub. No.: US 2026/0023388 A1
(43) Pub. Date: Jan. 22, 2026

(54) ROBOT CONTROL APPARATUS AND METHOD THEREOF

(71) Applicants: HYUNDAI MOTOR COMPANY, Seoul (KR); Kia Corporation, Seoul (KR)

(72) Inventor: Yun Sub Kim, Hwaseong-si (KR)

(21) Appl. No.: 18/958,748

(22) Filed: Nov. 25, 2024

(30) Foreign Application Priority Data
Jul. 19, 2024 (KR) 10-2024-0095876

(51) Int. Cl. G05D 1/622; G01S 17/89; G01S 17/931; G05D 1/246; G05D 111/10

(52) U.S. Cl. CPC G05D 1/622; G01S 17/89; G01S 17/931; G05D 1/2464; G05D 2111/17

(57) ABSTRACT

A robot control apparatus and a method thereof are provided. The robot control apparatus includes at least one sensor and a processor. The processor may be configured to obtain, via the at least one sensor and from an area within a designated distance from a robot, data points associated with one or more target objects around the robot, determine a first group of data points and a second group of data points, determine, based on an angle difference between the first group and the second group and based on a height difference between the first group and the second group, whether the first segmented area corresponds to a ground, and control, based on the determination of whether the first segmented area corresponds to the ground, movement of the robot.

### CROSS-REFERENCE TO RELATED APPLICATION

This application claims the benefit of priority to Korean Patent Application No. 10-2024-0095876, filed in the Korean Intellectual Property Office on Jul. 19, 2024, the entire contents of which are incorporated herein by reference.

### TECHNICAL FIELD

The present disclosure relates to a robot control apparatus and a method thereof, and more particularly, relates to technologies for identifying an external object.

### BACKGROUND

Recently, research on various technologies have been in progress in the field of robotics. Particularly, studies and developments are being conducted to improve technologies for allowing a robot to follow a target and move.

In order for a robot to plan a movement path and follow or trail a target, the robot must be able to accurately identify the target. To this end, there has been an ongoing research on identifying targets using various sensors.

### SUMMARY

The present disclosure has been made to solve the problems occurring in at least some implementations while advantages achieved by those implementations are maintained intact.

An aspect of the present disclosure provides a robot control apparatus for identifying a type of an external object and generating a driving path of a robot and a method thereof.

Another aspect of the present disclosure provides a robot control apparatus for identifying an external object using a sensor including LiDAR and a grid map to output an accurate result using a small amount of calculation and a method thereof.

Another aspect of the present disclosure provides a robot control apparatus for identifying an external object using sensor data and a grid map to quickly and accurately identify the external object and a method thereof.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a robot control apparatus may include: at least one sensor; and a processor. The processor may be configured to: obtain, via the at least one sensor and from an area within a designated distance from a robot, data points associated with one or more target objects around the robot, wherein the area is segmented, based on a designated angle and a designated length, into a plurality of segmented areas; determine, among the data points, a first group of data points that belong to a first segmented area of the plurality of segmented areas; determine, among the data points, a second group of data points that belong to one or more second segmented areas of the plurality of segmented areas, wherein the one or more second segmented areas are adjacent to the first segmented area; determine, based on an angle difference between the first group and the second group and based on a height difference between the first group and the second group, whether the first segmented area corresponds to a ground; and control, based on the determination of whether the first segmented area corresponds to the ground, movement of the robot.

The processor may be further configured to: determine, based on the first segmented area being determined to not correspond to the ground and based on a grid map, that the first segmented area corresponds to at least one of a static object, a dynamic object, or a mixed object.

The processor may be further configured to: determine, based on the first segmented area corresponding to the mixed object and based on the grid map, a partial dynamic object included in the first segmented area; and output at least one of the static object, the dynamic object, the mixed object, or the partial dynamic object.

The processor may be further configured to: determine, based on transforming a first coordinate system centered around the robot into a second coordinate system representing the grid map, the at least one of the static object, the dynamic object, the mixed object, or the partial dynamic object.

The processor may be further configured to: match, based on cropping the grid map to a designated size, the plurality of segmented areas with the grid map.

The processor may be further configured to: generate, based on the data points and while the robot is operating, a local map.

The processor may be further configured to: update the local map by performing, based on a movement of the robot, a delta transform on the local map.

The processor may be further configured to: exclude, based on a speed of an external object being greater than or equal to a designated speed or a type of the external object being identified as a designated type, the external object from the local map.

The processor may be further configured to: determine, based on a first representative point of the first group and a second representative point of the second group, at least one of the angle difference or the height difference.

The processor may be further configured to: assign, based on the designated angle and the designated distance, an identifier to each of the plurality of segmented areas.

According to one or more example embodiments of the present disclosure, a robot control method may be performed by an apparatus associated with a robot. The robot control method may include: obtaining, by a processor via at least one sensor and from an area within a designated distance from the robot, data points associated with one or more target objects around the robot, wherein the area is segmented, based on a designated angle and a designated length, into a plurality of segmented areas; determining, among the data points, a first group of data points that belong to a first segmented area of the plurality of segmented areas; determining, among the data points, a second group of data points that belong to one or more second segmented areas of the plurality of segmented areas, wherein the one or more second segmented areas are adjacent to the first segmented area; determining, based on an angle difference between the first group and the second group and a height difference between the first group and the second group, whether the first segmented area corresponds to a ground; and controlling, based on the determination of whether the first segmented area corresponds to the ground, movement of the robot.

The robot control method may further include: determining, based on the first segmented area being determined to not correspond to the ground and based on a grid map, that the first segmented area corresponds to at least one of a static object, a dynamic object, or a mixed object.

The robot control method may further include: determining, based on the first segmented area corresponding to the mixed object and based on the grid map, a partial dynamic object included in the first segmented area; and outputting at least one of the static object, the dynamic object, the mixed object, or the partial dynamic object.

The robot control method may further include: determining, based on transforming a first coordinate system centered around the robot into a second coordinate system representing the grid map, the at least one of the static object, the dynamic object, the mixed object, or the partial dynamic object.

The robot control method may further include: matching, based on cropping the grid map to a designated size, the plurality of segmented areas with the grid map.

The robot control method may further include: generating, based on the data points and while the robot is operating, a local map.

The robot control method may further include: updating the local map by performing, based on a movement of the robot, a delta transform on the local map.

The robot control method may further include: excluding, based on a speed of an external object being greater than or equal to a designated speed or a type of the external object being identified as a designated type, the external object from the local map.

The robot control method may further include: determining, based on a first representative point of the first group data points and a second representative point of the second group data points, at least one of the angle difference or the height difference.

The robot control method may further include: assigning, based on the designated angle and the designated distance, an identifier to each of the plurality of segmented areas.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a block diagram associated with a robot control apparatus according to an embodiment of the present disclosure;

FIG. 2 shows an example of a block diagram associated with a robot control apparatus according to an embodiment of the present disclosure;

FIG. 3 shows an example associated with classification of a point cloud, in an embodiment of the present disclosure;

FIG. 4 shows an example of filtering a ground and a non-ground, in an embodiment of the present disclosure;

FIG. 5 shows an example of determining a partial dynamic object, in an embodiment of the present disclosure;

FIG. 6 shows an example of a flowchart associated with a robot control method according to an embodiment of the present disclosure; and

FIG. 7 shows a computing system associated with a robot control apparatus or a robot control method according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical component is designated by the identical numerals even when they are displayed on other drawings. In addition, a detailed description of well-known features or functions will be ruled out in order not to unnecessarily obscure the gist of the present disclosure.

In describing components of exemplary embodiments of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

For purposes of this application and the claims, the example phrase “at least one of: A; B; or C” (or its equivalence such as “at least one of A, B, or C”) means “only A, or only B, or only C, or any combination of A, B and C (which includes any combination of A and B only; B and C only; A and C only; or all of A, B and C).” Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Based on one or more features (e.g., dividing a point cloud into one or more segmented areas) described herein, an operation of an object, such as a robot, may be controlled. The robot control may include various operational controls associated with the vehicle (e.g., autonomous movement control, sensor control, braking control, braking time control, acceleration control, acceleration change rate control, alarm timing control, forward collision warning time control, etc.).

One or more auxiliary devices (e.g., brake, hydraulic retarder, electric retarder, regenerative brake, etc.) may also be controlled, for example, based on one or more features (e.g., dividing a point cloud into one or more segmented areas) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., dividing a point cloud into one or more segmented areas) described herein.

Minimum risk maneuver (MRM) operation(s) may also be controlled, for example, based on one or more features (e.g., dividing a point cloud into one or more segmented areas) described herein. A minimal risk maneuvering operation (e.g., a minimal risk maneuver, a minimum risk maneuver) may be a maneuvering operation of a robot or a vehicle to minimize (e.g., reduce) a risk of collision with surrounding objects or people in order to reach a lowered (e.g., minimum) risk state. A minimal risk maneuver may be an operation that may be activated during autonomous movement control of the vehicle when an operator or user is unable to respond to a request to intervene. During the minimal risk maneuver, one or more processors of the robot or the vehicle may control a movement of the robot or the vehicle for a set period of time.

Biased movement control operation(s) may also be controlled, for example, based on one or more features (e.g., dividing a point cloud into one or more segmented areas) described herein. A movement control apparatus may perform a biased movement control. To perform a biased movement, the movement control apparatus may control the movement of the vehicle by maintaining a lateral distance between the position of the center of the robot or the vehicle and the center of a moving path or route. For example, the movement control apparatus may control the movement of the robot or the vehicle to stay in the path or route.

One or more sensors (e.g., IMU sensors, camera, light detection and ranging (LIDAR), radar, blind spot monitoring sensor, line departure warning sensor, distance sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., dividing a point cloud into one or more segmented areas) described herein.

An operation control for autonomous movement control of the robot or the vehicle may include various movement control of the robot or the vehicle by the movement control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

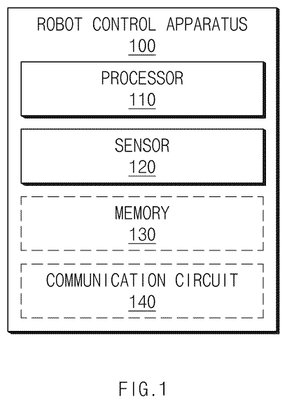

Hereinafter, embodiments of the present disclosure will be described in detail with reference to FIGS. 1 to 7.

FIG. 1 shows an example of a block diagram associated with a robot control apparatus according to an embodiment of the present disclosure.

Referring to FIG. 1, a robot control apparatus 100 according to an embodiment of the present disclosure may be implemented inside or outside a robot, and some of the components included in the robot control apparatus 100 may be implemented inside or outside the robot. In this case, the robot control apparatus 100 may be integrally configured with control units in the robot or may be implemented as a separate device to be connected with the control units of the robot by a separate connection means. For example, the robot control apparatus 100 may further include components which are not shown in FIG. 1.

According to an embodiment, the robot control apparatus 100 may include a processor 110 and a sensor 120. For example, the robot control apparatus 100 may include at least one of the processor 110, the sensor 120, a memory 130, or a communication circuit 140, or any combination thereof. For example, the processor 110, the sensor 120, the memory 130, and the communication circuit 140 may be electronically or operably coupled with each other by an electronical component including a communication bus.

Hereinafter, that pieces of hardware are operably coupled with each other may include that a direct connection or an indirect connection between the pieces of hardware is established wired and/or wirelessly, such that second hardware is controlled by first hardware among the pieces of hardware.

The different blocks are illustrated, but an embodiment is not limited thereto. Some of the pieces of hardware of FIG. 1 may be included in a single integrated circuit including a system on a chip (SoC). Types of the pieces of hardware included in the robot control apparatus 100 and/or the number of the pieces of hardware are/is not limited to those shown in FIG. 1. For example, the robot control apparatus 100 may include only some of the pieces of hardware shown in FIG. 1.

The robot control apparatus 100 according to an embodiment may include hardware for processing data based on one or more instructions. The hardware for processing the data may include the processor 110.

For example, the hardware for processing the data may include an arithmetic and logic unit (ALU), a floating point unit (FPU), a field programmable gate array (FPGA), a central processing unit (CPU), and/or an application processor (AP). The processor 110 may have a structure of a single-core processor or may have a structure of a multi-core processor including a dual core, a quad core, a hexa core, or an octa core.

For example, the sensor 120 may include hardware for detecting a surrounding environment of at least one of the robot control apparatus 100 or a robot including the robot control apparatus 100, or any combination thereof.

For example, the sensor 120 may include at least one of a depth sensor or odometry, or any combination thereof. For example, the depth sensor may include at least one of a time of flight (ToF) sensor, light detection and ranging (LiDAR), a structured light sensor, an ultrasonic sensor, an infrared sensor, an optical distance sensor, or a red, green, blue, depth (RGB-D) sensor, or any combination thereof.

The memory 130 of the robot control apparatus 100 according to an embodiment may include hardware for storing data and/or an instruction input and/or output by the processor 110 of the robot control apparatus 100.

For example, the memory 130 may include a volatile memory including a random-access memory (RAM) and/or a non-volatile memory including a read-only memory (ROM).

For example, the volatile memory may include at least one of a dynamic RAM (DRAM), a static RAM (SRAM), a cache RAM, or a pseudo SRAM (PSRAM), or any combination thereof.

For example, the non-volatile memory may include at least one of a programmable ROM (PROM), an erasable PROM (EPROM), an electrically erasable PROM (EEPROM), a flash memory, a hard disk, a compact disc, a solid state drive (SSD), or an embedded multi-media card (eMMC), or any combination thereof.

The communication circuit 140 of the robot control apparatus 100 according to an embodiment may include hardware for supporting transmission or reception of a signal between the robot control apparatus 100 and an external electronic device. For example, the communication circuit 140 may include at least one of a modem, an antenna, or an optic/electronic (O/E) converter, or any combination thereof.

For example, the communication circuit 140 may support transmission and/or reception of a signal, based on various types of protocols including at least one of an Ethernet, a local area network (LAN), a wide area network (WAN), wireless-fidelity (Wi-Fi), Bluetooth, Bluetooth low energy (BLE), ZigBee, long term evolution (LTE), 5th generation new radio (5G NR), a controller area network (CAN), or a local interconnect network (LIN), or any combination thereof.

The robot control apparatus 100 according to an embodiment may use a grid map (also referred to as a grid) stored in the memory 130. The robot control apparatus 100 according to an embodiment may receive the grid map via the communication circuit 140. For example, the processor 110 of the robot control apparatus 100 may use the grid map received via the communication circuit 140.

The processor 110 of the robot control apparatus 100 according to an embodiment may identify points (also referred to as data points) obtained by means of the at least one sensor 120 in partial regions (also referred to as partial areas or segmented areas) obtained by segmenting a region (also referred to as an area) within a designated distance from the robot, based on segmenting the region using a designated angle and a designated length. For example, the points may include points generated by light or a sound wave reflected from the external object, which are obtained by the at least one sensor 120. For example, the points may be included in a point cloud. Each point of the points may correspond to a specific location (e.g., coordinates) on the surface of an object.

For example, the processor 110 may assign an identifier for dividing the partial regions to each of the partial regions, based on the designated angle and the designated distance.

For example, the designated angle may include about 0.05 degrees. For example, the designated distance may include about 0.07 centimeters (cm). For example, the processor 110 may assign a first identifier to partial regions segmented by the designated angle. For example, the processor 110 may assign a second identifier to partial regions segmented by the designated distance. For example, the first identifier may be referred to as segment. For example, the second identifier may be referred to as bin.

In an embodiment, the processor 110 may identify a second group among the points, which is included in each of surrounding partial regions adjacent to a reference partial region among the partial regions, based on identifying a first group among the points, in the reference partial region.

In an embodiment, the processor 110 may identify that the reference partial region is one of a ground or a non-ground, based on an angle difference between the first group and the second group and a height difference between the first group and the second group.

For example, the processor 110 may identify a first representative point of the first group and a second representative point of the second group. For example, the first representative point of the first group may include a point, the height of which is highest from the ground, among the points included in the reference partial region. For example, the second representative point of the second group may include a point, the height of which is highest from the ground, among the points included in the surrounding partial region.

For example, the processor 110 may group the reference partial regions determined as the ground. For example, the processor 110 may group the reference partial regions determined as the non-ground. For example, the processor 110 may group the reference partial regions determined as the non-ground, using a designated algorithm (e.g., a density-based spatial clustering of applications with noise (DBSCAN) algorithm).

For example, the processor 110 may obtain at least one of a minimum value, a maximum value, an intermediate value, a virtual box, a concave, or a convex, or any combination thereof, using points included in each of sets of the grouped reference partial regions.

In an embodiment, the processor 110 may perform the following operations, based on obtaining the grid map by means of the memory 130 or the communication circuit 140.

In an embodiment, the processor 110 may identify that the reference partial region corresponds to at least one of a static object, a dynamic object, or a mixed object by using the grid map, based on that the reference partial region is identified as the non-ground.

For example, the static object may include at least one of a tree, a structure, a wall, or a curb, or any combination thereof. For example, the dynamic object may include an object which is not included in a structure which is not on the grid map. For example, the mixed object may include at least one of a person, mobility, or a vehicle, or any combination thereof. However, an embodiment of the present disclosure is not limited to those described above.

For example, the processor 110 may identify whether the reference partial region corresponds to the mixed object. For example, the processor 110 may identify a partial dynamic object which is included in the reference partial region by using the grid map, based on identifying that the reference partial region corresponds to the mixed object.

For example, the processor 110 may assign an identifier indicating the partial dynamic object to the partial dynamic object, based on identifying the partial dynamic object. For example, the identifier indicating the partial dynamic object may be referred to as “separated”.

For example, the processor 110 may identify whether the reference partial region and the grid map match with each other to identify the partial dynamic object included in the reference partial region. For example, the processor 110 may output at least one of the static object, the dynamic object, the mixed object, or the partial dynamic object, or any combination thereof.

For example, the processor 110 may transform a first coordinate system formed around (e.g., centered around) the robot into a second coordinate system representing the grid map. For example, the processor 110 may identify the at least one of the static object, the dynamic object, the mixed object, or the partial dynamic object, or the any combination thereof, based on transforming the first coordinate system formed around (e.g., centered around) the robot into the second coordinate system representing the grid map.

For example, the processor 110 may match the partial regions with the grid map, based on cropping the grid map to a designated size. For example, the designated size may include about 0.05 m×0.05 m.

For example, the processor 110 may plan a path for avoiding the at least one of the static object, the dynamic object, the mixed object, or the partial dynamic object, or the any combination thereof to control the robot, based on identifying the at least one of the static object, the dynamic object, the mixed object, or the partial dynamic object, or the any combination thereof.

In an embodiment, if not obtaining the grid map, the processor 110 may perform the following operations.

For example, while the robot including the robot control apparatus 100 is operating, the processor 110 may obtain points by means of the at least one sensor 120. For example, while the robot is operating, the processor 110 may generate a local map, based on the points obtained by means of the at least one sensor 120.

For example, the processor 110 may generate the local map with designated resolution. For example, the designated resolution may include a resolution of about 25.6 m×25.6 m or 0.05 m.

For example, while the robot is operating, the processor 110 may identify the external object. For example, the processor 110 may exclude the identified external object from the local map, based on that it is identified that the speed of the external object is greater than or equal to a designated speed.

For example, while the robot is operating, the processor 110 may identify a type of the external object. For example, the processor 110 may exclude the identified external object from the local map, based on that the type of the external object is identified as a designated type.

For example, the processor 110 may exclude the external object from the local map, if generating the local map, based on that the speed of the external object is greater than or equal to the designated speed or the type of the external object is identified as the designated type.

For example, the designated speed may include about 0.4 m/s. For example, the designated type may include a person (or a pedestrian).

For example, the processor 110 may perform delta transform for the local map updated at a (t−1)-th time point based on the movement of the robot. For example, the processor 110 may use the local map updated at the (t−1)-th time point as a local map at a t-th time point, based on performing the delta transform for the local map updated at the (t−1)-th time point.

As described above, the robot control apparatus 100 according to an embodiment may perform different operations, if it is able to obtain the grip and if it is unable to obtain the grid map. For example, if it is able to obtain the grid map, the robot control apparatus 100 may identify whether the external object is the dynamic object, using sensor data (e.g., data obtained using the sensor 120 and/or points obtained using the sensor 120), and may control the robot. For example, if it is unable to obtain the grid map, the robot control apparatus 100 may generate the local map, may identify whether the external object is the dynamic object, or may control the robot. By performing the above-mentioned operations, the robot control apparatus 100 may perform relatively safe driving. Furthermore, the robot control apparatus 100 may compare the grid map with the partial regions to identify whether the external object is the dynamic object, thus determining whether the external object is the dynamic object using a relatively small amount of calculation.

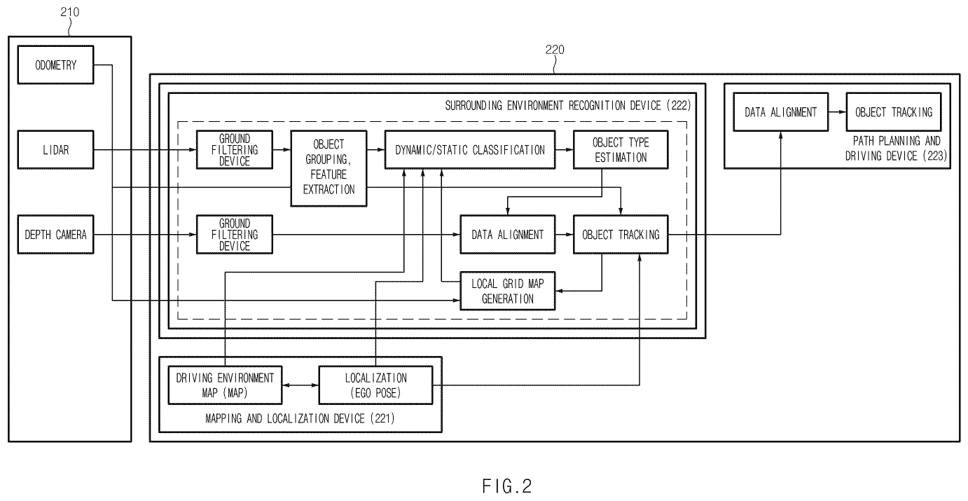

FIG. 2 shows an example of a block diagram associated with a robot control apparatus according to an embodiment of the present disclosure.

Referring to FIG. 2, a robot control apparatus (e.g., a robot control apparatus 100 of FIG. 1) according to an embodiment may include a hardware device 210 and a software device 220.

For example, the hardware device 210 of the robot control apparatus may include at least one of odometry, LiDAR, or a depth camera, or any combination thereof.

For example, the software device 220 of the robot control apparatus may include at least one of a mapping and localization device 221, a surrounding environment recognition device 222, or a path planning and driving device 223, or any combination thereof.

For example, a processor (e.g., a processor 110 of FIG. 1) of the robot control apparatus may obtain data by means of the hardware device 210.

For example, the processor may input the data obtained by means of the hardware device 210 to the software device 220.

For example, the processor may input LiDAR data obtained by means of the LiDAR to the surrounding environment recognition device 222. For example, the processor may input the LiDAR data to a ground filtering device included in the surrounding environment recognition device 222. For example, the LiDAR data may include a point cloud.

For example, the processor may perform object groping and feature extraction, based on inputting the LiDAR data to the ground filtering device. For example, the processor may perform dynamic/static classification, based on performing the object groping and the feature extraction. For example, the processor may classify the external object identified by the LiDAR data as a dynamic object or a static object.

For example, the processor may classify the external object as the dynamic object or the static object, based on a driving environment map included in the mapping and localization device 221, localization included in the mapping and localization device 221, and the LiDAR data.

For example, the processor may classify the external object as the dynamic object or the static object, based on a local grip map and the LiDAR data.

For example, the processor may perform object type estimation, based on classifying the external object identified by the LiDAR data. For example, the object type may include categories for classifying the type of the external object in detail.

In an embodiment, the processor may input camera data obtained by means of the depth camera to the surrounding environment recognition device 222. For example, the processor may input the camera data to the ground filtering device included in the surrounding environment recognition device 222. For example, the processor may perform data alignment, based on inputting the camera data to the ground filtering device.

In an embodiment, the processor may perform the data alignment using the camera data, based on performing the object type estimation. For example, the data alignment may include an operation for correcting a coordinate system. For example, the data alignment may include an operation for representing data represented on different coordinate systems on the same coordinate system.

In an embodiment, the processor may generate a local grip map, based on performing object tracking. For example, if the grid map is not prepared, the processor may generate the local grip map.

In an embodiment, the processor may perform the object tracking, based on performing the data alignment. For example, the processor may plan a path and may control a robot, using the path planning and driving device 223, based on performing the object tracking.

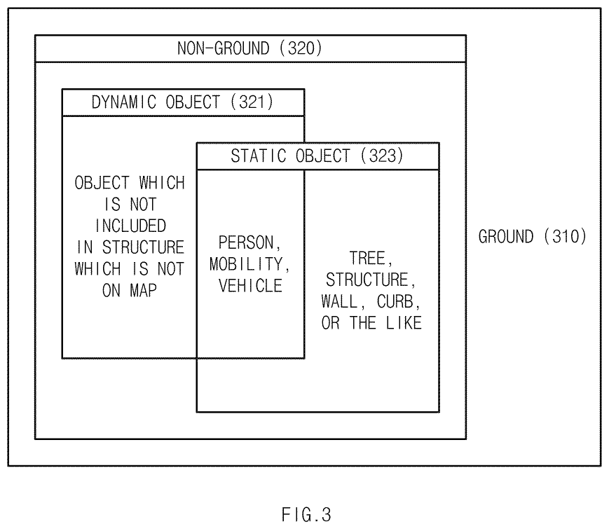

FIG. 3 shows an example associated with classification of a point cloud, in an embodiment of the present disclosure.

Referring to FIG. 3, a processor (e.g., a processor 110 of FIG. 1) of a robot control apparatus (e.g., a robot control apparatus 100 of FIG. 1) according to an embodiment may obtain a point cloud. For example, the processor may obtain the point cloud, using LiDAR.

For example, the processor may classify a type of the point cloud, based on obtaining the point cloud.

For example, the type of the point cloud may include a ground 310 and a non-ground 320. For example, the type of the non-ground 320 may include a dynamic object 321 and a static object 323. For example, the dynamic object 321 may include an object which is not included in a structure which is not on a map. For example, the static object 323 may include at least one of a tree, a structure, or a wall, or any combination thereof.

The type of the point cloud may include a mixed object in which the dynamic object 321 and the static object 323 overlap with each other. For example, the mixed object may include at least one of a person, mobility, or a vehicle, or any combination thereof.

For example, the processor may classify the type of the point cloud as at least one of the above-mentioned types. However, an embodiment of the present disclosure is not limited to those described above.

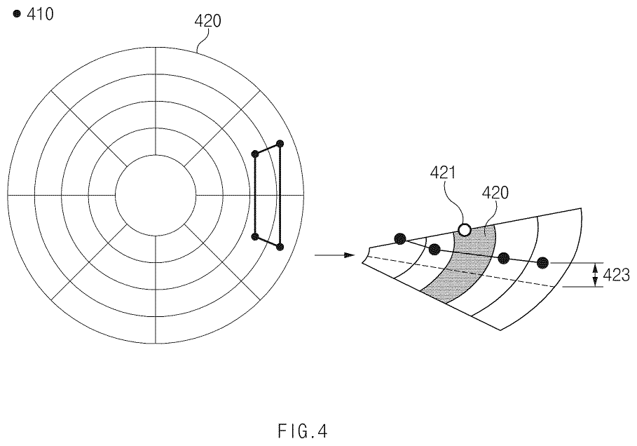

FIG. 4 shows an example of filtering a ground and a non-ground, in an embodiment of the present disclosure.

Referring to FIG. 4, a processor (e.g., a processor 110 of FIG. 1) of a robot control apparatus (e.g., a robot control apparatus 100 of FIG. 1) according to an embodiment may obtain a point cloud by means of LiDAR.

For example, the processor may segment a surrounding region of a robot including the robot control apparatus. For example, the processor may segment the surrounding region of the robot, using a grid 420. The grid may be a circular grid. The grid may consist of unit areas (also referred to as slots, unit spaces, unit cells, grid cells, partial regions, partial areas, or segmented areas) that are defined by the grid.

For example, the processor may identify a representative point 410 on each of the unit areas of the grid 420. For example, the representative point 410 may include a point with the largest z value among the points included in the grid 420.

In an embodiment, the processor may identify a height of the representative point 421 included in a unit area of the grid 420. For example, the processor may identify an average height 423 of representative points included in adjacent unit areas within the grid 420.

The processor may compare the height of the representative point 421 with the average height 423. The processor may determine a unit area of the grid 420 including the representative point 421 as a non-ground, based on that a difference between the height of the representative point 421 and the average height 423 is greater than a threshold.

For example, the processor may determine a unit area of the grid 420 and/or the representative point 421 as a ground and/or the non-ground and may determine a type of the unit area of the grid 420 and/or a type of the representative point 421, which are/is determined as the non-ground. The processor may determine the type of a unit area of the grid 420 and/or the type of the representative point 421 and may plan a driving path of the robot based on it.

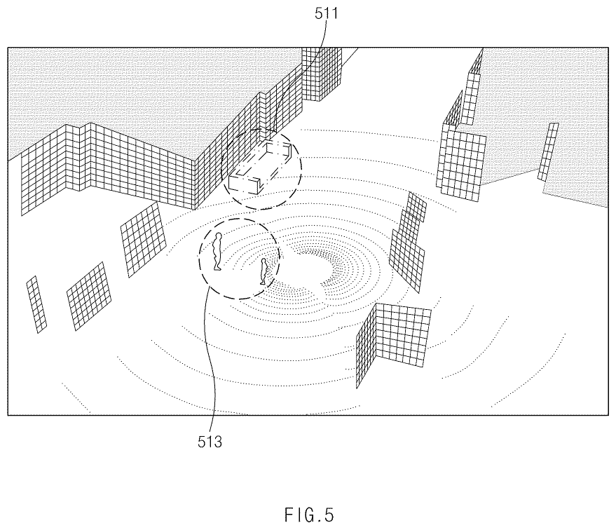

FIG. 5 shows an example of determining a partial dynamic object, in an embodiment of the present disclosure.

Referring to FIG. 5, a processor (e.g., a processor 110 of FIG. 1) of a robot control apparatus (e.g., a robot control apparatus 100 of FIG. 1 may identify whether a grid map and partial regions match with each other.

For example, the processor may represent partial regions represented on a first coordinate system on a second coordinate system. For example, the second coordinate system may include a coordinate system on which the grid map is represented.

For example, the processor may search for whether there is a matched structure, in each of the partial regions represented on the second coordinate system. For example, the processor may categorize objects matched with a structure in each of the partial regions. For example, the processor may classify the objects matched with the structure in each of the partial regions into one a static object, a dynamic object, or a mixed object.

For example, the processor may identify whether structures represented on the grid map and points included in the partial regions match with each other. For example, the processor may classify types of the points (or a point cloud) included in the partial regions, based on that the structures represented on the grid map and the points included in the partial regions match with each other.

For example, the processor may assign an identifier indicating a static object 511 to points corresponding to the static object 511, based on identifying the static object 511 among the points. For example, the processor may assign an identifier indicating a mixed object 513 to points corresponding to the mixed object 513, based on identifying the mixed object 513 among the points.

For example, the processor may generate a driving path of a robot for avoiding at least one of the static object 511 or the mixed object 513, or any combination thereof, based on identifying the at least one of the static object 511 or the mixed object 513, or the any combination thereof. For example, the processor may control the robot to move along the generated driving path, using the driving path.

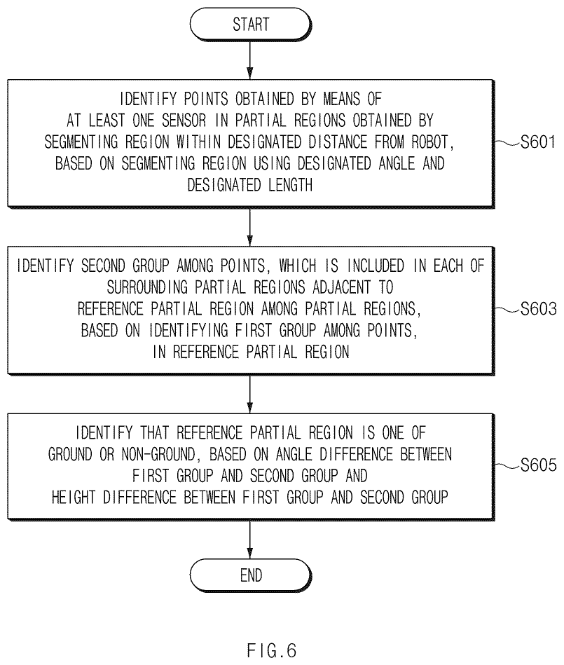

FIG. 6 shows an example of a flowchart associated with a robot control method according to an embodiment of the present disclosure.

Hereinafter, it is assumed that a robot control apparatus 100 of FIG. 1 performs a process of FIG. 6. Furthermore, in a description of FIG. 6, an operation described as being performed by an apparatus may be understood as being controlled by a processor 110 of the robot control apparatus 100.

At least one of the operations of FIG. 6 may be performed by the robot control apparatus 100 of FIG. 1. At least one of the operations of FIG. 6 may be controlled by the processor 110 of FIG. 1. The respective operations of FIG. 6 may be sequentially performed, but are not necessarily sequentially performed. For example, an order of the respective operations may be changed, and at least two operations may be performed in parallel.

Referring to FIG. 6, in S601, the robot control method according to an embodiment may include identifying points obtained by means of at least one sensor in partial regions obtained by segmenting a region within a designated distance from a robot, based on segmenting the region using a designated angle and a designated length.

In S603, the robot control method according to an embodiment may include identifying a second group among the points, which is included in each of surrounding partial regions adjacent to a reference partial region among the partial regions, based on identifying a first group among the points, in the reference partial region.

In S605, the robot control method according to an embodiment may include identifying that the reference partial region is one of a ground or a non-ground, based on an angle difference between the first group and the second group and a height difference between the first group and the second group.

For example, the robot control method may include identifying at least one of the angle difference or the height difference, or any combination thereof, based on a first representative point of the first group and a second representative point of the second group.

For example, the robot control method may include the following operations, if a grid map is prepared.

For example, the robot control method may include matching the partial regions with the grid map, based on cropping the grid map to a designated size.

For example, the robot control method may include classifying a type of each of the partial regions, based on whether the partial regions and the grid map match with each other.

For example, the robot control method may include identifying that the reference partial region corresponds to at least one of a static object, a dynamic object, or a mixed object by using the grid map, based on that the reference partial region is identified as the non-ground.

For example, the robot control method may include identifying a partial dynamic object included in the reference partial region by using the grid map, based on identifying that the reference partial region corresponds to the mixed object. For example, the robot control method may include outputting at least one of the static object, the dynamic object, the mixed object, or the partial dynamic object, or any combination thereof.

For example, the robot control method may include identifying the at least one of the static object, the dynamic object, the mixed object, or the partial dynamic object, or the any combination thereof, based on transforming a first coordinate system formed around (e.g., centered around) the robot into a second coordinate system representing the grid map.

For example, the robot control method may include the following operations, if the grid map is not prepared.

For example, the robot control method may include obtaining points by means of the at least one sensor, while the robot is operating. For example, the robot control method may include generating a local map, based on the points obtained by means of the at least one sensor, while the robot is operating.

For example, the robot control method may include identifying at least one of the static object, the dynamic object, or the mixed object, or any combination thereof, using the points obtained by means of the at least one sensor, and generating the local map, based on the identified at least one of the static object, the dynamic object, or the mixed object, or the any combination thereof.

For example, the robot control method may include generating the local map with designated resolution.

For example, the robot control method may include excluding an external object from the local map, if generating the local map, based on that the speed of the external object is greater than or equal to a designated speed or the type of the external object is identified as a designated type.

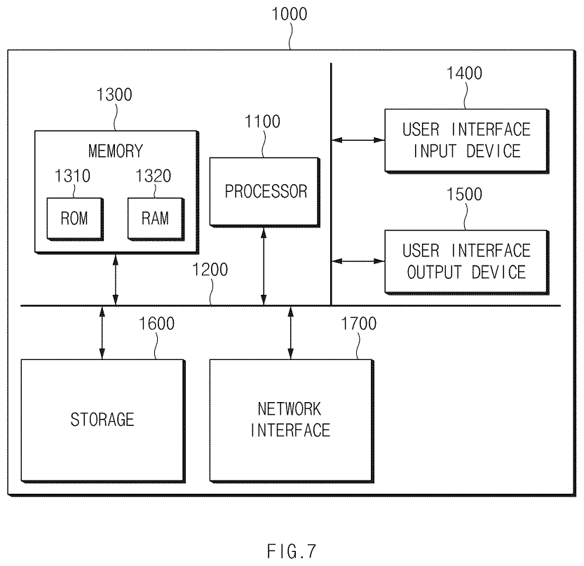

FIG. 7 shows a computing system associated with a robot control apparatus or a robot control method according to an embodiment of the present disclosure.

Referring to FIG. 7, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The present technology may identify a type of an external object and may generate a driving path of a robot.

Furthermore, the present technology may identify the external object using a sensor including LiDAR and a grid map to output an accurate result using a small amount of calculation.

Furthermore, the present technology may identify the external object using sensor data and the grid map to quickly and accurately identify the external object.

In addition, various effects ascertained directly or indirectly through the present disclosure may be provided.

According to an aspect of the present disclosure, a robot control apparatus may include at least one sensor and a processor. The processor may identify points obtained by means of the at least one sensor in partial regions obtained by segmenting a region within a designated distance from a robot, based on segmenting the region using a designated angle and a designated length, may identify a second group among the points, the second group being included in each of surrounding partial regions adjacent to a reference partial region among the partial regions, based on identifying a first group among the points, in the reference partial region, and may identify that the reference partial region is one of a ground or a non-ground, based on an angle difference between the first group and the second group and a height difference between the first ground and the second ground.

In an embodiment, the processor may identify that the reference partial region corresponds to at least one of a static object, a dynamic object, or a mixed object by using a grid map, based on that the reference partial region is identified as the non-ground.

In an embodiment, the processor may identify a partial dynamic object included in the reference partial region by using the grip map, based on identifying that the reference partial region corresponds to the mixed object, and may output at least one of the static object, the dynamic object, the mixed object, or the partial dynamic object, or any combination thereof.

In an embodiment, the processor may identify the at least one of the static object, the dynamic object, the mixed object, or the partial dynamic object, or the any combination thereof, based on transforming a first coordinate system formed around the robot into a second coordinate system representing the grid map.

In an embodiment, the processor may match the partial regions with the grid map, based on cropping the grid map to a designated size.

In an embodiment, the processor may generate a local map, based on the points obtained by means of the at least one sensor, while the robot is operating.

In an embodiment, the processor may generate the local map with designated resolution.

In an embodiment, the processor may exclude an external object from the local map, if generating the local map, based on that a speed of the external object is greater than or equal to a designated speed or a type of the external object is identified as a designated type.

In an embodiment, the processor may identify at least one of the angle difference or the height difference, or any combination thereof, based on a first representative point of the first group and a second representative point of the second group.

In an embodiment, the processor may assign an identifier for dividing the partial regions to each of the partial regions, based on the designated angle and the designated distance.

According to another aspect of the present disclosure, a robot control method may include identifying points obtained by means of at least one sensor in partial regions obtained by segmenting a region within a designated distance from a robot, based on segmenting the region using a designated angle and a designated length, identifying a second group among the points, the second group being included in each of surrounding partial regions adjacent to a reference partial region among the partial regions, based on identifying a first group among the points, in the reference partial region, and identifying that the reference partial region is one of a ground or a non-ground, based on an angle difference between the first group and the second group and a height difference between the first ground and the second ground.

The robot control method according to an embodiment may further include identifying that the reference partial region corresponds to at least one of a static object, a dynamic object, or a mixed object by using a grid map, based on that the reference partial region is identified as the non-ground.

The robot control method according to an embodiment may further include identifying a partial dynamic object included in the reference partial region by using the grip map, based on identifying that the reference partial region corresponds to the mixed object, and outputting at least one of the static object, the dynamic object, the mixed object, or the partial dynamic object, or any combination thereof.

The robot control method according to an embodiment may further include identify the at least one of the static object, the dynamic object, the mixed object, or the partial dynamic object, or the any combination thereof, based on transforming a first coordinate system formed around the robot into a second coordinate system representing the grid map.

The robot control method according to an embodiment may further include matching the partial regions with the grid map, based on cropping the grid map to a designated size.

The robot control method according to an embodiment may further include generating a local map, based on the points obtained by means of the at least one sensor, while the robot is operating.

The robot control method according to an embodiment may further include generating the local map with designated resolution.

The robot control method according to an embodiment may further include excluding an external object from the local map, if generating the local map, based on that a speed of the external object is greater than or equal to a designated speed or a type of the external object is identified as a designated type.

The robot control method according to an embodiment may further include identifying at least one of the angle difference or the height difference, or any combination thereof, based on a first representative point of the first group and a second representative point of the second group.

The robot control method according to an embodiment may further include assigning an identifier for dividing the partial regions to each of the partial regions, based on the designated angle and the designated distance.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the embodiments disclosed in the present disclosure is not intended to limit the technical idea of the present disclosure and is intended to describe it, and the scope of the technical idea of the present disclosure is not limited by the embodiments. The scope of the present disclosure should be construed on the basis of the accompanying claims, and all the technical ideas within the scope equivalent to the claims should be interpreted as being included in the claims of the present disclosure.

What is claimed is:

1. A robot control apparatus comprising:
at least one sensor; and
a processor,
wherein the processor is configured to:
obtain, via the at least one sensor and from an area within a designated distance from a robot, data points associated with one or more target objects around the robot, wherein the area is segmented, based on a designated angle and a designated length, into a plurality of segmented areas;
determine, among the data points, a first group of data points that belong to a first segmented area of the plurality of segmented areas;
determine, among the data points, a second group of data points that belong to one or more second segmented areas of the plurality of segmented areas, wherein the one or more second segmented areas are adjacent to the first segmented area;
determine, based on an angle difference between the first group and the second group and based on a height difference between the first group and the second group, whether the first segmented area corresponds to a ground; and
control, based on the determination of whether the first segmented area corresponds to the ground, movement of the robot.

2. The robot control apparatus of claim 1, wherein the processor is further configured to:
determine, based on the first segmented area being determined to not correspond to the ground and based on a grid map, that the first segmented area corresponds to at least one of a static object, a dynamic object, or a mixed object.

3. The robot control apparatus of claim 2, wherein the processor is further configured to:
determine, based on the first segmented area corresponding to the mixed object and based on the grid map, a partial dynamic object included in the first segmented area; and
output at least one of the static object, the dynamic object, the mixed object, or the partial dynamic object.

4. The robot control apparatus of claim 3, wherein the processor is further configured to:
determine, based on transforming a first coordinate system centered around the robot into a second coordinate system representing the grid map, the at least one of the static object, the dynamic object, the mixed object, or the partial dynamic object.

5. The robot control apparatus of claim 2, wherein the processor is further configured to:
match, based on cropping the grid map to a designated size, the plurality of segmented areas with the grid map.

6. The robot control apparatus of claim 1, wherein the processor is further configured to:
generate, based on the data points and while the robot is operating, a local map.

7. The robot control apparatus of claim 6, wherein the processor is further configured to:
update the local map by performing, based on a movement of the robot, a delta transform on the local map.

8. The robot control apparatus of claim 6, wherein the processor is further configured to:
exclude, based on a speed of an external object being greater than or equal to a designated speed or a type of the external object being identified as a designated type, the external object from the local map.

9. The robot control apparatus of claim 1, wherein the processor is further configured to:
determine, based on a first representative point of the first group and a second representative point of the second group, at least one of the angle difference or the height difference.

10. The robot control apparatus of claim 1, wherein the processor is further configured to:
assign, based on the designated angle and the designated distance, an identifier to each of the plurality of segmented areas.

11. A robot control method performed by an apparatus associated with a robot, the robot control method comprising:
obtaining, by a processor via at least one sensor and from an area within a designated distance from the robot, data points associated with one or more target objects around the robot, wherein the area is segmented, based on a designated angle and a designated length, into a plurality of segmented areas;
determining, among the data points, a first group of data points that belong to a first segmented area of the plurality of segmented areas;
determining, among the data points, a second group of data points that belong to one or more second segmented areas of the plurality of segmented areas, wherein the one or more second segmented areas are adjacent to the first segmented area;
determining, based on an angle difference between the first group and the second group and a height difference between the first group and the second group, whether the first segmented area corresponds to a ground; and
controlling, based on the determination of whether the first segmented area corresponds to the ground, movement of the robot.

12. The robot control method of claim 11, further comprising:
determining, based on the first segmented area being determined to not correspond to the ground and based on a grid map, that the first segmented area corresponds to at least one of a static object, a dynamic object, or a mixed object.

13. The robot control method of claim 12, further comprising:
determining, based on the first segmented area corresponding to the mixed object and based on the grid map, a partial dynamic object included in the first segmented area; and
outputting at least one of the static object, the dynamic object, the mixed object, or the partial dynamic object.

14. The robot control method of claim 13, further comprising:
determining, based on transforming a first coordinate system centered around the robot into a second coordinate system representing the grid map, the at least one of the static object, the dynamic object, the mixed object, or the partial dynamic object.

15. The robot control method of claim 12, further comprising:
matching, based on cropping the grid map to a designated size, the plurality of segmented areas with the grid map.

16. The robot control method of claim 11, further comprising:
generating, based on the data points and while the robot is operating, a local map.

17. The robot control method of claim 16, further comprising:
updating the local map by performing, based on a movement of the robot, a delta transform on the local map.

18. The robot control method of claim 16, further comprising:
excluding, based on a speed of an external object being greater than or equal to a designated speed or a type of the external object being identified as a designated type, the external object from the local map.

19. The robot control method of claim 11, further comprising:
determining, based on a first representative point of the first group data points and a second representative point of the second group data points, at least one of the angle difference or the height difference.

20. The robot control method of claim 11, further comprising:
assigning, based on the designated angle and the designated distance, an identifier to each of the plurality of segmented areas.
